(19) United States
(12) Patent Application Publication
(10) Pub. No.: US 2004/0142226 A1
(43) Pub. Date: Jul. 22, 2004

(54) Polymer electrolyte membrane fuel cell and bipolar plate

(76) Inventors: Hiroshi Yamauchi, Hitachi (JP); Kou Takahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/650,772

(22) Filed: Aug. 29, 2003

(30) Foreign Application Priority Data
Nov. 14, 2002 (JP) 2002-330857

(51) Int. Cl. H01M 8/02; H01M 8/10

(52) U.S. Cl. 429/38; 429/35; 429/30

(57) ABSTRACT

A solid polymer fuel cell has a separator in which a separator board formed therein passages and manifolds are interposed between two frames. The separator board includes coupling parts between the manifold and the passages, which have a digit-like or grid-like support structure, and the coupling parts are held between the frames within spaces in a gas introduction manifold and a gas discharge manifold which are formed in the separator board. With this arrangement, reaction gas flows through spaces which are defined, within the coupling parts formed in the separator board, by the digit-like parts or the grid-like parts and the two frames. With this configuration, gas crossing along the separator board is prevented. Further, with the provision of parts for turning back reaction gas on the insides of the frames, a serpentine passage structure can be obtained.

### BACKGROUND OF THE INVENTION

The present invention relates to a polymer electrolyte membrane fuel cell and bipolar plate.

Among various kinds of fuel cells, a solid polymer type fuel cell includes, as a main feature, an MEA (Membrane Electrode Assembly) provided with carbon electrodes composed of a polymeric solid electrolyte membrane and catalyst such as platinum carried by the solid electrolyte membrane, and a pair of separators between which the MEA is interposed, and which is formed therein with passages for hydrogen gas as fuel and oxidant gas (oxygen or air), capable of carrying out power collection. Thus, the type having this configuration is the so-called unit cell which is one of those stacked one upon another in a fuel cell stack.

In the above-mentioned configuration, the separator is adapted to efficiently feed reactive gas to the electrodes and is made of carbon group or metal group electro-conductive materials. It is noted here that the reactive gas is generic for the fuel gas and the oxidant gas.

There have been so many kinds of separators which are mainly sorted into two groups, that is, one of which is the internal manifold type group in which reactive gas is fed through through-holes formed in the separator, and the other one of which is an external manifold group in which no through-holes for passing reactive gas are formed in the separator, and reactive gas is fed from opposite sides of the separator.

Further, they can be sorted into several groups in view of kinds of separators having surface structures which make contact with diffusion layers. For example, there are presented a separator having a surface making contact with an electrode (diffusion layer) and having an unevenness pattern and a separator which is in combination of a planar plate and an inter collector having an unevenness pattern or a groove pattern. As to the materials for the separators are mainly sorted into two groups, that is, a carbon group and a metal group. Of these groups, the metal group is prosperously used since it is less expensive and is excellent in mass productivity. Since a metal thin plate can be used, a fuel cell made therefrom can be compact and light-weight.

However, the metal material tends to cause deterioration of a cell or an increase in internal resistance due to corrosion or a growth of a nonconductive film, and to have difficulty of plastic processing because fine grooves are needed for bipolar plate. There have been proposed various methods which can solve these problems of corrosion and a growth of a nonconductive film. Further in order to make up for a disadvantage caused by the formation of grooves, the combination with an inter collector or a metal plate formed therein passage grooves is used. For example, JP-A-8-222237 or JP-A-10-07530 discloses a technology of forming a separator from a single metal plate. The conventional separator of this kind is composed of a single metal plate formed therein passage grooves and a frame surrounding the metal plate. Since this separator is formed from a single metal plate, a less number of components may be used, and accordingly, it is advantageous in view of the costs thereof.

This separator causes another problem, that is, a coupling part provided between the manifold and the electrode surface passage structure has unevenness in order to feed and discharge reaction gas between the manifold and the electrode surface, and accordingly, gas crossing is caused so that the reaction gas leaks from one to opposite electrode. In order to solve this problem, there is disclosed as first measures, unevenness-like grooves which are formed between the manifold and the passages, and further, there is disclosed, as second measures, the coupling part having a tunnel-like shape. The first measures would cause such a problem that a seal material or an electrolytic film is deformed by a fastening pressure so as to block recess grooves or to create gaps, resulting in gas crossing through which the reaction gas leaks from one to the opposite electrode through the gaps. The second measures are devised so as to solve the above-mentioned problems. For example, as disclosed in JP-A-9-35726, the coupling part is covered over its upper surface with the plate member. Further, as disclosed in JP-A-2000-133289, the coupling part is coated with resin, except gas passage grooves, so as to aim at preventing the planar plate from peeling off or enhancing the gas sealing ability. Further, as disclosed in JP-A-2000-164227, the gas flow resistance is improved. As disclosed in proceedings (proceeding number A1-12) for 8-th Fuel Cell System Symposium held by The Fuel Cell Development Center, May 15 to 16, 2001, passages having the so-called submarine structure are formed in the coupling part in order to eliminate the necessity of the plate member.

The above-mentioned configurations have been able to be applied to a material having a thickness of about 1 to 2 mm, which is excellent in the formation of passage grooves in the manifold, as in a carbon group separator or the like. However, if has been difficult to apply the above-mentioned configurations to a separator which is formed of a metal plate by stamping. Metal used as the material has a wall thickness of about 0.2 mm, that is, it is thin, and accordingly, this wall thickness is not sufficient for forming a tunnel-like structure or a submarine structure in the manifold part of the coupling part.

A further function desired for the separator is to efficiently supply reaction gas to electrodes. In such a case that the separator is made of a carbon group material, any desired passage configuration can be formed so that an effectively separator can be easily obtained, but in the case of a metal separator, the freedom for the formation is low in comparison with the carbon group one since a limitation is presented to a plasticity process for the metal separator. On the contrary, in the case of a graphite separator, a serpentine passage structure (meandering passage structure) can be formed in each of opposite surfaces of a single separator. However, it is difficult form this structure through metal working.

The serpentine passage configuration allows the passages to have any desired suitable length, and accordingly, uniform distribution of gas streams can be facilitated. Thus, it is devised that with a combination of several metal plates, a desired distribution of gas entrances which can be obtained. However, with the configuration of straight passages which can be simply formed by pressing, the uniform distribution of gas streams is difficult with this configuration. Thus, this configuration is not essential, in particular, for power generation with a high output power density. Further, since the gas streams are not uniformly distributed, electrochemical reaction becomes not uniform, and accordingly, it is not preferable in view of the use life of the electrodes.

It is usual to carry out working of the center part of a metal thin plate from which an internal manifold in a separator for a fuel cell is formed, so as to form passage grooves and protrusion defining passages through which reaction gas flows. Thus formed separator has a peripheral part around the passage grooves, which is sill a mere plate. Accordingly, it is required to cover the peripheral part thereover with frames having a wall thickness corresponding to the part from which the passage grooves are extruded, and to adjust this thickness. It is indispensable to form a passage through which the gas flow from the manifold to the passages, and accordingly a frame which is simply formed by punching a plate material cannot be used. As a result, a gas introduction passage which extends from the manifold to the passage grooves should be formed in the frame itself. Thus, the number of process steps is increased due to forming the passage grooves in the frame.

### SUMMARY OF THE INVENTION

An object of the present invention is to prevent occurrence of gas crossing between a separator composed of a separator board and two frames, and an electrolytic film making contact with the separator.

According to the present invention, manifolds serving entrances formed in the separator board are formed in a digital shape or a grid-like shape, and accordingly, it is eliminate the necessity of forming passage grooves in the frames themselves. Accordingly, frames which are simply punched out can be used. Further, according to the present invention, since no passages are formed in the frames, it is possible to prevent the reaction gas from crossing caused by deformation of a frame or an MEA in the coupling part adjacent the manifold. Further, passages for turning back the reaction gas can be formed in the frames while only mere straight passages are formed in the separator board, thereby it is possible to obtain serpentine (meandering) passages.

The present invention utilizes measures which can prevent recess grooves in the coupling part from being blocked due to corruption of an electrolytic film or a seal material, and which can also prevent gas crossing causing reaction gas to leak into an opposite electrode through a gap created thereby. Further, there is used measures with which serpentine passages can be obtained even thought mere straight passages are formed in the separator board.

In a conventional separator which is formed from a single metal plate, frame members are required at the outer peripheral part of the separator. In addition, it is necessary to form gas passage grooves for introducing and discharging reaction gar between a manifold and the passage grooves (corresponding to the coupling part) in the frame members. Thus, a complicated manufacturing method should be therefore used. According to the present invention, no formation of passages for communication with the manifold is required in the frame member, thereby it is possible to aim at simplifying the manufacturing method thereof.

According to a first aspect of the present invention, there is provided a fuel cell comprising a polymer electrolytic membrane having an ionic conductivity, a pair of electrode portions interposing therebeween the electrolytic member, and a separator for supplying fuel gas and oxidant gas to the electrode portions. The separator is formed therein with a separator board formed therein passages such as grooves, manifolds, and coupling parts between the manifold and the passages. There are provided frames which are made into area-contact respectively with the front and rear surfaces of the separator board so as to have a function of sealing the reaction gas, and the coupling part has an opening part extending from the front to rear surface of the separator board and space parts defined between opposite surfaces of the separator board and the pair of frames making contact therewith. The frames and the passages are prevented from overlapping with each other in the stacking direction of the separator and the electrodes. Thus, even though a pressure is exerted in the stacking direction, the frames can be prevented from being deformed, thereby it is possible to eliminate creation of any gap which causes gas crossing, between the separators and the frames.

With the configuration of the separator according to the present invention, the plurality of separators are stacked one upon another so as to obtain a fuel cell which causes less gas crossing, and which can have an appropriate passage structure, thereby it is possible to reduce the costs thereof and as well to enhance the generated output power, the efficiency and the use life.

Further, according to the present invention, there is provided a separator comprising a separator board formed therein grooves and manifolds for supplying reaction gas serving as fuel and oxidant to electrodes, and frames making contact with the front and rear surfaces of the separator board and having a function of sealing the reaction gas. The separator has passage grooves and manifolds as entrances for reaction gas in the front surface thereof. Further, coupling parts are formed between the manifolds and the passage grooves. The coupling parts include opening parts extending from the front to rear surface of the separator board, and the reaction gas can pass through space parts defined between the opposite surfaces of the separator board and the two frames making contact therewith.

According to another aspect of the present invention, the coupling parts in the separator in the above-mentioned aspect, have a digit-like or grid-like shape. A pair of frames mated with each other, interposing the coupling parts therebetween, and the reaction gas can pass through spaces defined between the frames and the digit-like or grid-like coupling parts. The frames have all an equal thickness. Further, the frames are formed therein with passage grooves for changing the direction of the gas stream or are formed on the inside thereof with one or more protrusions for blocking the reaction gas so as to prevent the reaction gas flowing into adjacent passage grooves.

According to further another aspect of the present invention, the separator and the frames are made of metal materials and polymer materials, respectively. The front and rear surfaces of the separator are formed in part or over the entire part with electro-conductive corrosion-resistant layers, and each of the frames has a multi-layer structure having not less than one layer. According to further another aspect of the present invention, there is provided a fuel cell comprising an electrolytic portion having at least ionic conductivity, and electrode portions interposing therebetween the electrolytic portion, and a separator for supplying reaction gas to the electrode portions.

The present invention will be described in the form of preferred embodiments with reference to the accompanying drawings in which Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a perspective view illustrating a fuel sell separator in a first embodiment of the present invention;

FIG. 2 is a sectional view along line A-A in FIG. 1;

FIG. 3 is a partial perspective view illustrating a deformed condition of an MEA and frames around a manifold;

FIG. 4 is an exploded perspective view illustrating a separator having coupling parts between manifolds and passage grooves which are formed in a digit-like or grid-like shape;

FIG. 5A is a top view illustrating the separator shown in FIG. 4;

FIG. 5B is a longitudinal sectional view illustrating the separator shown in FIG. 4;

FIG. 5C is a bottom view illustrating the separator assembly shown in FIG. 4;

FIG. 6 is a longitudinal sectional view illustrating a stack of separators each of which is shown in FIG. 4 in order to show a flow pattern of reaction gas;

FIG. 7 is a partial perspective view illustrating a digit-like or grid-like coupling part in the separator;

FIG. 8 is a partial perspective view illustrating a digit-like or grid-like coupling part in the separator;

FIG. 9 is a sectional view along line B-B in FIG. 5;

FIG. 10 is a perspective view illustrating a separator having frames formed therein passages;

FIG. 11 is a partial perspective view illustrating a separator having frames formed therein protrusions with which a serpentine passage is defined;

FIG. 12A is a top view illustrating a separator having frames which are formed in a digit-like shape in a part making contact with a coupling part of a separator board;

FIG. 12B is a longitudinal section view illustrating the separator shown in FIG. 12A;

FIG. 12C is a bottom view illustrating the separator shown in FIG. 12A; and

FIG. 13 is a partial perspective view illustrating a fuel cell using separator boards stated in a second embodiment.

### DESCRIPTION OF PREFERRED EMBODIMENTS OF THE INVENTION

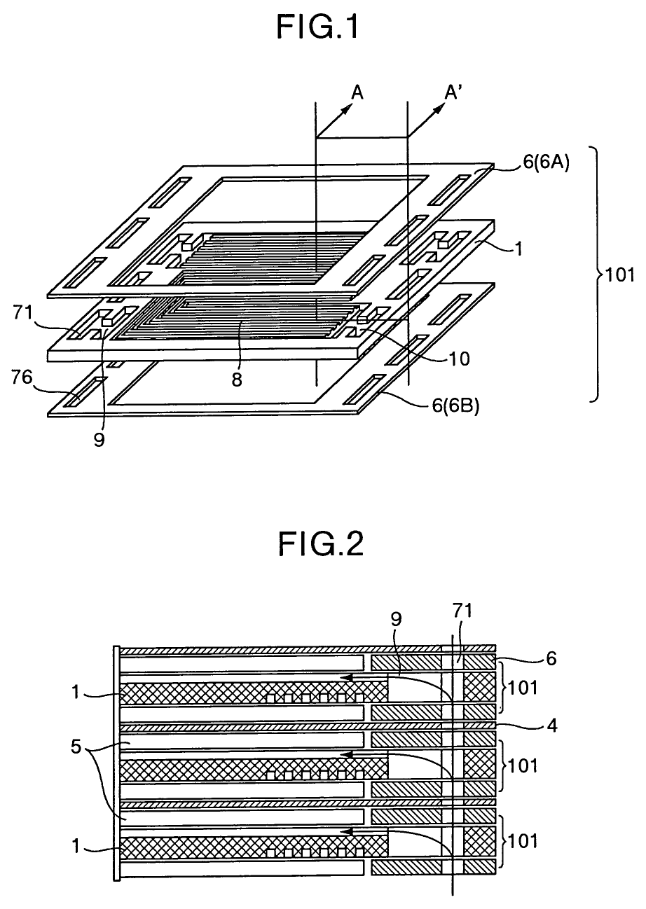

The explanation will be made of several embodiments in the form of a solid polymer type fuel cell as an example, with reference to FIGS. 1 to 3.

### Embodiment 1

Referring to FIG. 1 which shows a separator for a fuel cell in an embodiment 1 of the present invention, a separator board 1 is formed therein with six manifolds 71 in total, four of them being located respectively in four corner parts of the separator board and two being located respectively in the center parts of opposite end parts thereof. The separator board 1 is formed in its center part with 1.5 reciprocation type passage grooves 8. A frame 5A and a frame 6B are made into surface-contact with opposite surfaces of the separator board 1, respectively, so as to constitute a separator assembly. The frames 6A and 6B have a shape substantially identical with that of the separator board 1, and also have a planer structure in which parts of the frames making contact with the passage grooves 8 and the manifolds 71 are punched out. Since the frames 6A, 6B are made into surface-contact with the separator board 1, space parts 9 are defined between them, extending from the manifolds 71 to the passage grooves 8. Thus, reaction gas flows between the manifolds 71 and the passage grooves 8 once by way of the space parts 9.

Referring to FIG. 2 which is a sectional view along line A-A in FIG. 1, illustrating the manifolds 71 in the separator boards 1, there are also shown MEAs (Membrane Electrode Assembly; electrodes carrying catalyst are coated, stuck or printed on a polymer electrolytic film) 4 and gas diffusion layers (electrode) 5. Each of the MEAs 4 is composed of a polymer electrolytic member 2 made of a sulfonated fluorine group resin or the like, and carbon electrodes carrying catalyst such as platinum or the like and coated, stuck or printed on the polymer electrolytic member 2.

The reaction gas flows from the manifolds 71, 76 into the passage grooves 8 by way of the space parts 9. The separator board 1 can be formed by mechanically cutting a carbon material such as graphite or a mixture of resin and a carbon material. Further, there may be used such a measure that a mixture of resin and a carbon material is cast into dies defining therein with manifolds and passage grooves, so as to carry out heat compression molding or extruding molding. Similarly, the separator board may be formed of a metal material by mechanical working, die-forging, extrusion-molding, casting, press-molding or the like. The frame is preferably made of polymer rubber such as EPDM (ethylene propylene rubber), fluorine group rubber or silicon group rubber, which is particularly excellent in gas-tight ability, heat-resistance and chemical-resistance although the material thereof should not be limited to these materials.

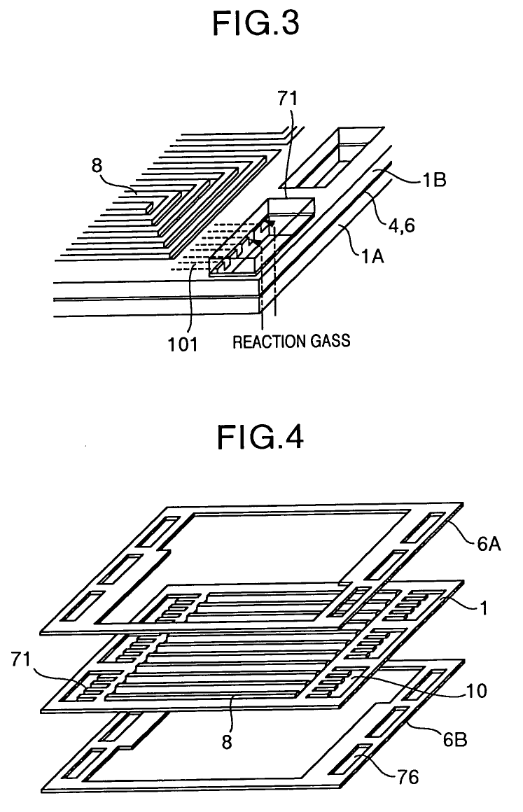

Explanation will be hereinbelow made of the structure of a coupling part in a conventional separator. The frame is usually made of a rubber material which is easily deformable, in order to maintain seal ability. The frame itself has a weak strength, and accordingly, is deformed by a fastening force exerted when it is stacked on the separator so as to cause U-like sagging which easily cause gas crossing. FIG. 3 shows an example of this situation in which the MEA 4 and the frames 6 are clamped between two separator boards 1A, 1B, and are fastened by a predetermined pressure. In this situation, the MEA 4 and the frames 6 which are made of rubber or the like would be deformed so as to wedge into grooves in coupling parts 10 through which reaction gas is led from the manifolds 71 into the passage grooves 8.

Such deformation causes a gap between an end face of the separator board 1B and an end face of the MEA 4 in the coupling part where the separator board 1B, the MEA 4 and the frames 6 are made into close contact with one another so as to maintain a gas tight condition, and this gap is exposed to the manifold 7. Thus, gas leaks from one to an opposite electrode through the gap which is created by the deformation. On the contrary, according to this embodiment of the present invention, the space part 8 itself constitutes the coupling part 10 where no end faces of the fames 6 and the MEA 4 are present, thereby it is possible to restrain occurrence of gas crossing.

### Embodiment 2

In the embodiment 2, explanation will be made a metal separator having coupling parts 10 formed in a digit-like shape so as to simplify the configuration of the frames.

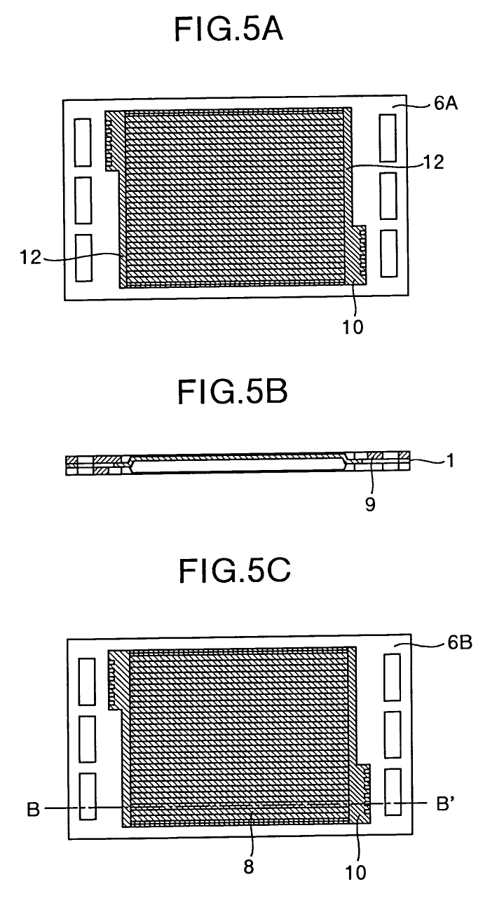

FIG. 4 which shows an example in which the coupling part 10 extending from the manifolds 71 and the passage grooves 8 are formed in a digit-like or a grid-like shape. FIGS. 5A to 5C show a configuration of an assembly in which a separator board 1 is made into surface-contact with frames 6A, 6B, in which FIG. 5B is a sectional view illustrating the separator along line B-B′ in FIG. 5C, FIG. 5A is a plan view illustrating the assembly as viewed from the frame 6A made into surface-contact with the front surface of the separator board 1 while FIG. 5C is a plan view illustrating the assembly, as viewed the frame 6B made into surface contact with the rear surface of the separation board 1. As clearly understood from these figures, the space parts 9 (the coupling parts 10) defining the manifolds have structures which are not made into press-contact with the frames.

The separator board 1 is made of a metal thin plate by stamping, and has a configuration in which passage grooves are formed in the center part of the separator board while manifolds 71 are formed in the peripheral part thereof. The frames 6A, 6B are made into surface-contact with the separator board 1B which is therefore interposed therebetween. The separator board 1 has digit-like structures extending from the manifolds to the passage grooves 8 (corresponding to the coupling parts 10), and the digit-like structures are interposed between the two frames 6A, 6B so as to define the space parts 9 (corresponding to the coupling parts 10).

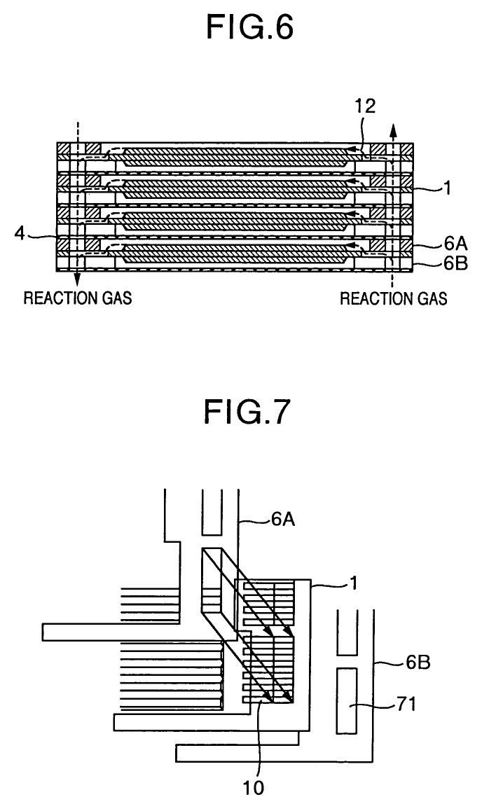

Reaction gas flows through the thus formed space parts 9, is then distributed by a header part, and is finally fed into the passage grooves 8. It is noted here that the parts where the frames 6A, 6B are mated with each other, interposing the digit-like parts therebetween have such configuration that either one of the frames completely covers the digit-like parts while the other one thereof allows the digit-like parts to be in part exposed. Thus, reaction gas flowing into the digit-like parts flows along the side where the digit-like parts are exposed, and accordingly, the reaction gas is prevented from reaching an arbitrary surface other than a specific surface. FIG. 6 is a sectional view which shows a stack of a plurality of separator boards in order to understand the above-mentioned situation. It is here that gas diffusion layers 5 and cooling cells for cooling the fuel cell are not shown in this figure for the purpose of simplification.

With the above-mentioned configuration, no passages for feeding and distributing reaction gas from the manifolds 71 into the passage grooves 8 are required to be formed in the frames 6 which can be therefore simply formed by punching. The thus formed frames 6 have a uniform wall thickness throughout thereof.

### Embodiment 3

The necessity of the formation of passage recesses in the frames 6 is not required in the embodiment 2 since the digit-like parts are formed in the coupling parts 10 from the manifolds 71 to the coupling parts 10. A similar function can be obtained by the provision of a grid-like or a semigrid-like structure in the coupling parts. FIG. 7 shows this configuration.

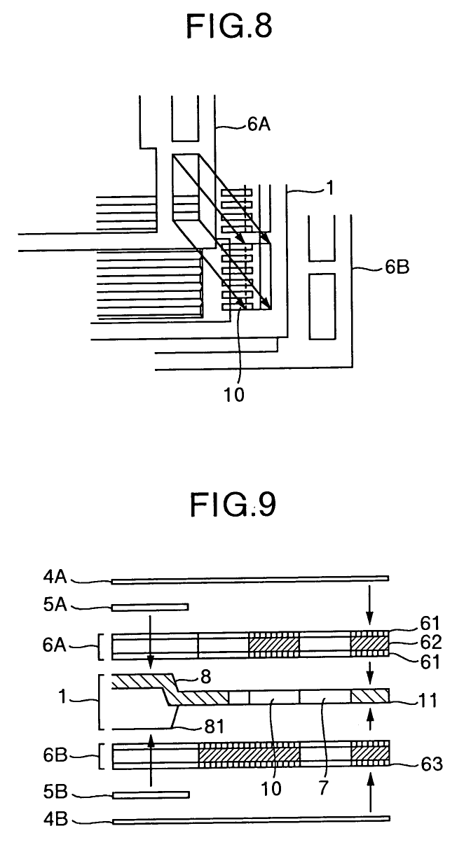

FIG. 7 is an enlarge view illustrating a part around one of the manifolds 7 in the embodiment 2 having a configuration the same as the embodiment 1, except that the structures of the coupling parts 10 and the manifolds 71 are different from those in the embodiment 1. A difference between the digit-like structure as shown in FIG. 4 and the grid-like structure is appreciated, depending upon whether digits of the digit-like parts extend up to the associated manifolds or not. The former only has one of four sides serving as a retaining piece during press-punching, and accordingly, if fine digits are formed, the digits are twisted or slip away from press-die retainers, accidentally, possibly resulting in that they cannot be precisely formed. On the contrary, the latter has two of four sides which can be held by die retainers, and accordingly, fine working can be easily made thereto. The same effect can be obtained by a configuration shown in FIG. 8 in which a part of a grid-like part is located in the manifold 7.

Although the separator board 1 explained in the embodiment 1 and the embodiment 2 is formed of a metal thin plate, it may be formed of a carbon group material, having a similar structure.

### Embodiment 4

The material of the frames are not specified in the embodiment 2 and the embodiment 3, that is, the material thereof should not be limited to a specific one. They can be formed with a similar function and advantage, through punching or mechanical working of a metal or resin material, and through various measures such as extraction-molding or the like. Measures for making the frames into surface contact with the separator board 1 should not be limited to a specific one. Any substance may be used if it is thermally stable at an operating temperature of a fuel cell, and if it dose not change its quality by water, steam or the like. In the case of the provision of a gasket function the frames 6 for gas-tight, a material to be selected preferably has a low degree of hardness.

For example, EPDM (ethylene propylene rubber), silicon rubber, fluorine rubber or the like is excellent in heat-resistance and chemical resistance. It is noted here that the frames 6 made of a material with a low degree of hardness (high elasticity) would be collapsed toward the separator board 1 in the digital or grid-like shape parts, possibly resulting in blocking gas passages or gas crossing with reaction gas. In order to prevent occurrence of this matter, the frame 6 has a multilayer structure including at least one layer made of a material having a low degree of elasticity in order to maintain a stiffness for the frame 6, thereby it is possible to prevent occurrence of blocking of the gas passage and gas crossing. Explanation will be hereinbelow made of an example of this configuration.

FIG. 9 shows a sectional view along line B-B′ shown in FIG. 5C, illustrating a part around the right side manifold, as an example. The frames 6A, 6B have a three layer structure, that is, it includes outer layers parts 61 made of rubber, and a middle layer part 62 made of resin. As to the outer layer parts 61, a soft material having a degree of hardness of about 50 to 60 (IRHD, International Rubber Hardness) is selected in order to obtain a frame which has a soft outer surface and which has a gas tight ability, as the frame 6A or 6B. The outer layers-of the frame 6A or 6B are formed of EPDM, and the middle layer thereof is made of a PET (Polyethylene Terephtalate) film. Further, the PET layer has, for example, a wall thickness of 0.4 mm while the EPDM has a wall thickness of 0.1 mm, and the entire wall thickness of the frame becomes 0.6 mm.

The above-mentioned frames 6A, 6B are formed by covering a PET sheet with two EPDM sheets, and by pressing the same with a thermal pressure roll. The separator board 1 has such a structure that an Type 316L stainless steel plate having a wall thickness of 0.4 mm is press-formed so as to extrude passage grooves 8 from the front and rear sides of this plate in the center part of the latter. The height difference between a position 11 where the separator board 1 is made into contact with the frame 6B and the apices 81 of the passage grooves 8 is 0.4 mm. Further, a height difference between a position 63 of the front surface of the frame after the frames 61A, 61B are made into surface contact with the separator board 1, and the apicies 81 is 0.2 mm. Within this height difference of 0.2 mm, gas diffusion layers 5A, 5B are laid while MEAs 4A, 4B are made into surface-contact with the outer surface of the gas diffusion layers.

Since the frames 6A and 6B have outer layers 61 which are made of EPDM rubber as shown in FIG. 9, gas-tightness can be satisfactorily maintained as they are made into contact with the separator board 1 and the MEAs 4A, 4B. Further, since the middle layer 62 is made of a thick and hard PET material, no deformation is caused even if the fuel cell is fastened, thereby it is possible to prevent occurrence of gas blocking or gas crossing in the coupling part 10.

If a tolerance to the wall thickness of the frames 6A, 6B is small in comparison with the wall-thickness of the MEAs 4A, 4B, the MEAs 4a, 4b may be used, instead of sealing gaskets. Usually, the film thickness of the MEAs 4A, 4B is about 20 μm at a minimum, but is 100 to 200 μm at a maximum. If the tolerance to the wall thickness of a material from which the frames 6A, 6B are formed is small, unevenness of the frame 6 can be absorbed by the film itself, thereby it is possible to effect gas tightness. Thus, it is not required to provide layers 61 having a resiliency on the surfaces of the frames with which the MEAs 4A, 4B are made into contact, and accordingly, the frame may have a two layer structure such as a PET/EPDM layer structure.

Further, if the frames 6A, 6B are fixed to the separator board 1 through the intermediary of adhesive, the frames 6A, 6B can have a single layer structure made of a hard material. Similar to the material of the frames 6A, 6B, the adhesive should not be limited to a specific one if it is heat-resistant, chemical-resistant and water-proof. As a typical adhesive, liquid gasket and silicon sealant and the like which are commercially available may be preferably used since these materials have both sticking function and sealing function.

### Embodiment 5

Explanation will be made of an embodiment in which the frames 6 in the embodiments stated above, are formed in passage grooves for turning back reaction gas.

The separation has such a function that reaction gas is efficiently fed to the electrodes, and a voltage and a current are transmitted to adjacent separators with no loss in a power produced through power generation. In particular, in the configuration of the passage grooves 8, a groove width, a groove depth and a flowing direction are determined in view of a pressure loss of reaction gas, a draining ability of produced water, a thermal distribution caused by reaction, electric resistance and the like which greatly affect the use life and power generating function of the fuel cell. In such a case that the separator board 1 is formed from a carbon plate or a metal plate by mechanical working so as to form the separator, the separator can have an optional shape. In a method in which a thin metal plate is press-formed so as to form passage grooves, the metal material is subjected to plastic working, and accordingly, limitations to the working would be present, in dependence upon material characteristics including a degree of hardness, a strength and an elongation of the metal material. Should the separator be formed by working, exceeding the above-mentioned limitations, warping, clacking or the like would be caused. Thus, it is difficult to form a desired passage groove configuration.

Usually, in order to enhance the performance and the use life of the fuel cell, it is devised that the flow rate of reaction gas flowing through the passage grooves is increased so as to increase the supply speed of reaction gas onto the electrodes while produced water is smoothly drained. Thus, the separators have passage configurations which are more or less of serpentine (meandering) type. Through the press-forming of a thin metal plate, it is difficult to form a serpentine structure having a suitable passage width and depth due to the limitations to the working of the material. Further, should a serpentine structure be formed in such a type that reaction gas flows along both front and rear surfaces of a single metal plate, the positions of manifolds through which oxidant gas and fuel gas are fed, respectively, would be coincident with each other, and accordingly, it is difficult to form a serpentine passage in a separator which is formed by pressing a single metal plate.

Explanation will be hereinbelow made of an embodiment in which passage grooves and the like for turning back reaction gas are formed in the frames, and accordingly, a separator having straight passage grooves which can be press-formed in a relatively simple manner can have a serpentine passage configuration.

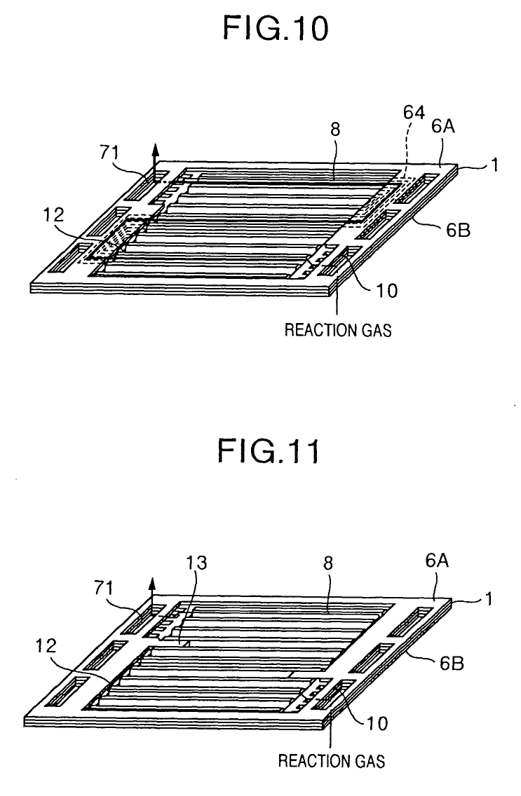

FIG. 10 is a perspective view which shows a separator having frames 6A, 6B in which passage grooves are formed, and which also shows a stream pattern of reaction gas. As clearly understood from this figure, space parts 9 are formed in a communicated separator board 1 which is made of a SUS316L stainless steel plate by press-forming, having the same shape as shown in FIG. 4. Frames 6A, 6B made of PPS (polyphenylene sulfide) formed by extrudon molding are stuck to opposite surfaces of the separator board 1 through the intermediary of silicon sealant.

In addition to the manifolds 71, the frames 6A, 6B are also formed therein with turning back passage grooves 11. Reaction gas flows into the passage grooves 8 through the manifolds 71 and the coupling parts 10 defined by the frames 6A, 6B interposing therebetween the separator board, After passing through the passage grooves 8, the reaction gas comes into the turning back passage grooves 11. End parts of the turning back passage grooves are made into close contact with the passage grooves 8, and accordingly, the reaction gas flows through the turning back passage grooves 11 without overflowing into adjacent passage grooves 8. Through the turning back passage grooves 11, the flowing direction of the reaction gas is changed by an angle of 180 deg., then the reaction gas flows from the turning back passage grooves 11 into the passage grooves 8, and thereafter, it flows into the next turning back flow passage grooves. After the repetitions of the above-mentioned flowing manner, the reaction gas is discharged from the manifolds 71.

Although in this embodiment, the turning back passage grooves 11 are formed on the opposite sides of the separator board 1, the same effect can be obtained by such a configuration that the surface of the turning back passage grooves 11 are faced to the separator board 1. In this configuration, it is required to prevent the coupling parts 10 and the tuning back passage grooves 11 from overlapping with each other. Thus, with the provision of the turning back passages 11 in the frames 6A, 6B, the pressed separator having straight passage grooves can have a serpentine passage configuration, thereby it is possible to increase the flow rate of the reaction gas.

Similar effects can be obtained by the following frame structure. Referring to FIG. 11 which shows an example in which protrusions 13 are formed on the insides of the frames 6A, 6B, the protrusions 13 are adapted to block the reaction gas so as to prevent the same from flowing into adjacent passage grooves 8. With this configuration, a serpentine passage groove configuration can also be obtained. Reaction gas having flown through straight passage grooves cannot pass through by the protrusions 13 when it comes to the head part, and accordingly, it changes its flowing direction by an angle of 180 deg. Also in this way, a serpentine passage configuration can be obtained.

The above-mentioned embodiments are typical ones, and accordingly, the present invention can be applied to any of separators for various kinds of fuel cells, independent from a number of manifolds and positions thereof. The shape of the coupling parts 10 should not be limited to a specific one if reaction gas can flow through spaces defined between the separator board 1 and the two frames 6A, 6B. For example, if a separator board 1 having a thin wall thickness is selected, the cross-sectional area of the coupling part 10 through which reaction gas flows is inevitably decreased. An decrease in the cross-sectional area causes an increase in pressure loss, resulting in an energy loss.

In the above-mentioned embodiments, although one side of the rectangular manifold is adjacent to the digit-like coupling part 10, the present invention should not be limited to this configuration, but the manifold may be connected to the coupling part by way of other sides thereof. With this configuration, the cross-sectional area of the coupling part 10 can be increased. Although either metal or carbon can be used as the material of the separator board 1, the frames 5 and the like, according to the present invention, the present invention is effective in the case of the separator board 1 formed of metal by pressing. Accordingly, in this embodiment, explanation will be made of an example in which typical stainless steel is used.

In the above-mentioned embodiments, with the provision of passages for turning back reaction gas in the frames, the serpentine passage structure can be easily formed even though simple straight passages are formed in the separator board. Thus, the gas streams can be uniformly maintained, thereby it is possible aim at enhancing the output voltage, the use life, the power generation performance and the like. With a planar separator which is made of a thin metal plate and which has passage grooves in its center part and manifolds in its outer peripheral part, it is not necessary to form gas introduction parts in the frame itself, and accordingly, frames simply formed by punching can be used.

### Embodiment 6

In the above-mentioned embodiments, since no support for sufficiently retaining the MEA 4 is present on the inside of the coupling part 10 as shown in FIG. 6, the MEA 4 would be pressed toward a lower pressure side by a differential pressure between fuel gas and oxidant gas when the differential pressure is increased. As a result, the gas streams are hindered. In this embodiment, this problem is solved by such a configuration that the frame 6 is formed in parts on the inside of the coupling parts 10 in a digit-like shape in order to limit deformation of the MEA in the coupling part.

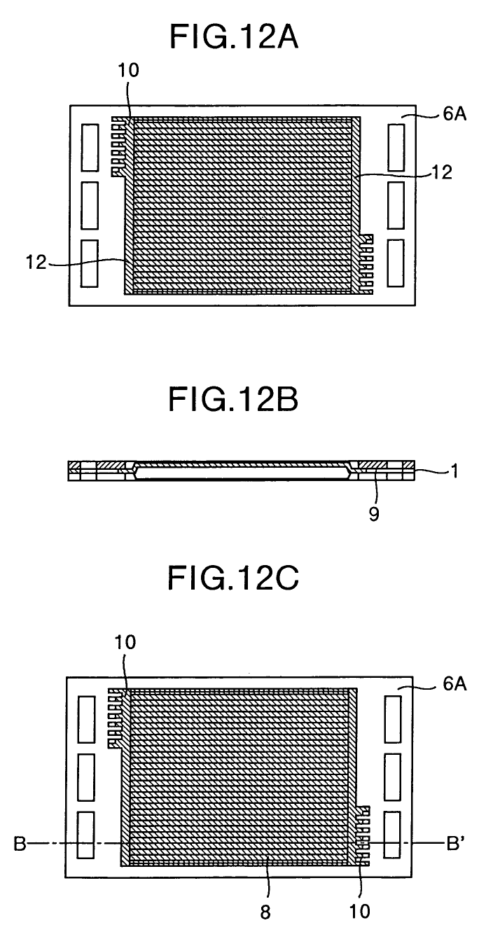

FIGS. 12A to 12C show a separator assembly in which the frames 6 are formed in a digit-like shape in parts facing the coupling parts 10 of the separator board 1. FIG. 12B is sectional view along line B-B′ in FIG. 12C, illustrating the separator, and FIG. 12A is a plan view illustrating the assembly as viewed from the frame 6A made into surface contact with the front surface of the separator board 1 while FIG. 12C is a plan view illustrating the assembly as viewed from the frame 6B made into surface contact with the rear surface of the separator board 1. Since no supports are present in the coupling parts 10 shown in FIGS. 5A to 5C, it would be likely to deform the MEA 4. However, in the configuration shown in FIGS. 12A to 12C, since the digit-like parts are formed in the frames 6A, 6B inside of the coupling parts 10, supports for the MEA 4 can be obtained, and accordingly, it is possible to restrain the MEA from being deformed. In these figures, FIG. 12 shows the front surface of the separator assembly, FIG. 12B shows the cross-section of the separate assembly along line B-B′ in FIG. 12C, and FIG. 12C shows the rear surface of the separator assembly.

### Embodiment 7

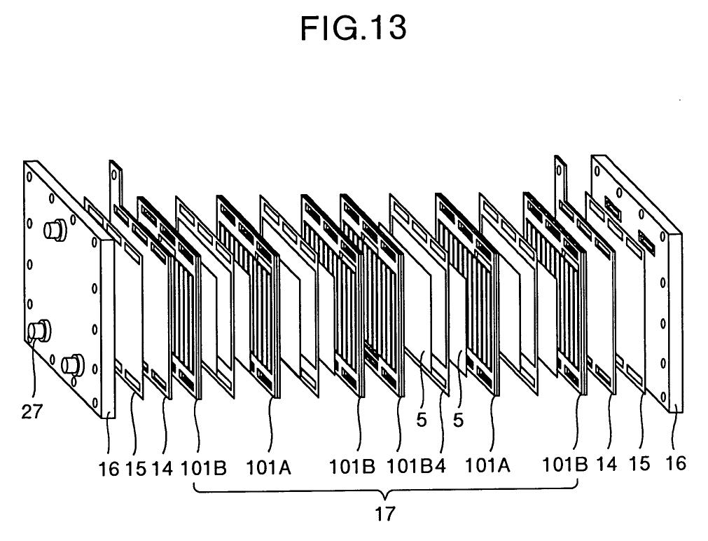

Explanation will be made of an example of a cell stack using separators 101 in the above-mentioned embodiments. FIG. 13 shows a configuration of a fuel cell using separators explained in the embodiment 2 as an example. This cell is composed of a plurality of separators and the other components. That is, a separator 101A (or a surface of a separator board 1B where reaction gas flows), a gas diffusion layer 5, an MEA 4, a gas diffusion layer 5 and a separator 101A (or a surface of the separator board 1B where reaction gas flows) are stacked one upon another in the mentioned order. In the parts where cooling water flows, the separator 101B and the separator 101B are used in combination, that is, the separator 101B and the separator 101B are mated with each other so as to define space parts between recesses, through which cooling water flows.

The difference between the separator 101A and the separator 101B is such that the separator 101A allows reaction gas to flow on opposite surfaces of the separator while the separator 101B allows cooling water on either one of opposite surfaces thereof. The stack of the separators, the gas diffusion layers 5 and the MEAs 4 is held between collector plates 14 for extracting a current and a voltage from the stack, insulator plates 15 for electrically isolating an power generating portion, and end plates 16 for fixing the stack. The fuel cell according to the present invention is composed of four MEAs 4 (a four cell configuration), and cooling is carried out by the separator boards 1B adjacent to both end plates 16 and two separator boards 1B located at the center of the power generating portion 17. During power generation, reaction gas is blown into a reaction gas introduction ports 27 provided to the end plate 16 on one side, and unreacting reaction gas is discharged from the end plate on the other side.

In order to carry out power generation with the use of the fuel cell according to the present invention, GORE SELECT PRIMEA5510 manufactured by a Japan Gore Tex Co., was used for the MEA 4 while a CARBEL-CL manufactured by the same company was used for the diffusion layer 5. Either of the separator 101A and the separator 101B had such a configuration that the separator board 1 was made of stainless steel, having concave and convex grooves formed by pressing on both surfaces thereof in the center part. The dimensions of the pressed part was 90 mm×100 mm, and the MEA 4 was formed so as to have a size corresponding to the above-mentioned dimensions.

Frames 6 formed of PRS by punching were stuck to both surfaces of the separator board 1 by adhesive such as liquid gasket, so as to form the separator assembly 101A. The cooling separator 101B also had the same shape as that of the separator 101A, having manifold parts through which coolant flows and which are digit-like. Accordingly, one and the same kind of the separator boards 1 could be used as separators for power generation, and separators for cooling, and accordingly, it was excellent in view of lower costs.

The separators as stated above were coated thereover with a conductive paint composed of carbon powder for corrosion prevention and oxide film growth suspension and resin binder. As to a coating method, there may be used various methods including screen printing, dip coating, transfer coating and spray coating. In this case, the paint was coated on the top surface of the convex and concave surface of the separator board 1 by means of screen printing which can easily control the thickness of a coating film.

When fuel gas and oxidant gas were fed to the thus configured fuel cell, a voltage (electromotive force) was generated between two collector plates 14. When 100% hydrogen as the fuel gas and the air as the oxidant gas were fed, an electromotive force of about 4 V was generated. Further, a suitable load is connected to the collector plates 14, a current ran so as to enable supply of power. In order to examine a cell characteristic of the fuel cell according to the present invention, an electronic loading unit which was commercially available was connected to the fuel cell so as check the relationship between a current and a voltage.

100% hydrogen as the fuel gas and the air as the oxidant gas (the outlet side of the fuel cell was opened to the atmosphere) were selected, and the utilization factors of them were set to 80% and 40%, respectively, so as to carry out power generation while a cell temperature of 70 deg.C. and a due point of 70 deg.C. for the supply gas were controlled. As a result, an output voltage of 3.0 V (0.75 per cell) with a current density of 0.25 A/cm² was obtained over a period of not less than 100 hours. In the case of a separator made of carbon, which was formed by cutting so as to have a configuration the same as that of this embodiment, a value equivalent to the above-mentioned value could be obtained. It was found that a sufficient performance could be obtained even with a pressed metal separator.

The embodiments stated above are typical ones, and the present invention can be applied, independent from a number of manifolds and positions thereof. The configuration of the coupling parts 10 should not be limited to a specific one if reaction gas can flow through spaces defined by the separator board 1 and the two frames 6.

In the embodiments stated above, although one side of each of the rectangular manifolds is adjacent to the corresponding digit-like coupling part 10, the present invention should not be limited to this configuration, but the manifold may be connected to the coupling part with the use of other sides thereof. With this configuration, the cross-sectional area of the coupling part can be increased. The present invention can be applied to a separator board 1, frames 6 and the like made of either metal or carbon. In particular, the present invention is effective for a pressed metal separator board 1. Thus, in this embodiment, the example using typical stainless steel has been explained.

In order to facilitate positional alignment when the separator board 1 and the frames 6 are made into surface contact with each other, protrusions and recesses or the like may be provided to the separator board 1 and the frames 6. With this configuration, they are made into surface contact with the each other with a high degree of accuracy and a high degree of efficiency.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A solid polymer type fuel cell comprising a polymer electrolyte having an ion conductivity; a pair of electrodes interposing therebetween the polymer electrolyte; and a separator for supplying fuel gas and oxidant gas respectively to the pair of electrodes, the separator including a separator board having a front surface and a rear surface, and a pair of frames made into surface contact with the front surface and the rear surface of the separator board, for sealing the fuel gas and the oxidant gas or cooling water, wherein members for supporting manifolds in the pair of frames are provided in spaces in a gas introduction manifold and a gas discharge manifold which are formed in the separator board.

2. A solid polymer type fuel cell comprising a polymer electrolyte having an ionic conductivity; a pair of electrodes interposing therebetween the polymer electrolyte; a separator for supplying fuel gas and oxidant gas respectively to the pair of electrodes, the separator including a separator board having a front surface and a second surface and having passages for supplying the gases to the electrodes, and manifolds and coupling parts formed between the manifolds and the passages, and a pair of frames made into surface contact with the front surface and the rear surface of the separator board, for sealing the fuel gas and the oxidant gas or cooling water, wherein each of the coupling parts has an opening extending from one surface to the other surface of the separator, and a space part defined by between the separator and the pair of frames made into surface contact with the separator.

3. A solid polymer type fuel cell as set forth in claim 1, wherein the coupling parts in the separator are digit-like or grid-like, the pair of frames are mated with each other, interposing therebetween the coupling parts, and reaction gas flow through spaces defined by the pair of frames and the digit-like coupling parts.

4. A solid polymer type fuel cell as set forth in claim 1, wherein the pair of frames are formed therein with passage grooves for changing the flowing direction of the reaction gas.

5. A solid polymer type fuel cell as set forth in claim 1, wherein the frames are provided on their insides with one or more of protrusions for preventing reaction gas from overflowing into adjacent passage grooves.

6. A separator for a solid polymer type fuel cell, comprising a separator board having a front surface and a rear surface; and a pair of frames made into surface contact with the front surface and the rear surface of the separator board, for sealing the fuel gas and the oxidant gas or cooling water; wherein members for supporting manifolds in the frames are provided in spaces in a gas introduction manifold and a gas discharge manifold which are formed in the separator board.

7. A separator for a solid polymer type fuel cell, comprising a separator board having a front surface and a rear surface and formed therein with passage grooves for supplying reaction gas to the electrodes, manifolds and coupling parts between the manifolds and the passage grooves; and a pair of frames made into surface contact with the front surface and the rear surface of the separator board, for sealing the fuel gas and the oxidant gas or cooling water; wherein each of the coupling parts has an opening extending from one surface to the other surface of the separator, and a space part defined by between the separator and the pair of frames made into surface contact with the separator.

8. A separator as set forth in claim 6, wherein the pair of frames are formed therein with passage grooves for changing the flowing direction of the reaction gas.

9. A separator as set forth in claim 7, wherein the frames are provided on their insides with one or more of protrusions for preventing reaction gas from overflowing into adjacent passage grooves.

10. A separator for a fuel cell as set forth in claim 7, wherein the separator board and the frames are made of a metal material and a polymer material, respectively, the separator board is formed with a conductive corrosion preventing layer on the front surface thereof over in part or in its entirety, and the frames have a single layer structure or a multilayer structure.
